(19) United States
(12) Patent Application Publication
(10) Pub. No.: US 2012/0229927 A1
(43) Pub. Date: Sep. 13, 2012

(54) LENS DRIVING DEVICE, CAMERA MODULE MOUNTED WITH THE LENS DRIVING DEVICE, AND MOBILE TELEPHONE MOUNTED WITH THE CAMERA MODULE

(76) Inventors: Suguru Ohishi, Osaka (JP); Hiroshi Yamashita, Aichi (JP); Mituo Nakashima, Osaka (JP)

(21) Appl. No.: 13/512,710

(22) PCT Filed: Dec. 1, 2010
(86) PCT No.: PCT/JP2010/071450

§ 371 Date: May 30, 2012

(30) Foreign Application Priority Data
Dec. 4, 2009 (JP) 2009-276485

(51) Int. Cl. G02B 7/04

(52) U.S. Cl. 359/826

(57) ABSTRACT

An object of the present invention is to provide a lens driving device that prevents looseness during movement of the holder caused by repeated contact and separation between sliding contact sections and the shaft, with a simple configuration. The lens driving device includes holder (10) that holds a lens unit and is movable in the direction of the optical axis of the lens unit; columnar shaft (51) extended in the direction of the optical axis; and further guide unit (15) provided on holder (10), that slidingly contacts the side of shaft (51) and guides the moving direction of the holder in the direction of the optical axis of the lens unit while the holder is moving. Guide unit (15) includes multiple sliding contact sections (15a) and (15b) that always continue to slidingly contact the side of the shaft at the same part while the holder is moving.

THIS APPLICATION IS A U.S. NATIONAL PHASE APPLICATION OF PCT INTERNATIONAL APPLICATION PCT/JP2010/071450.

### TECHNICAL FIELD

The present invention relates to a lens driving device for moving a lens module in the direction of the optical axis guided by a shaft disposed in the direction of the optical axis, to a camera module incorporating the lens driving device, and to a mobile telephone incorporating the camera module.

### BACKGROUND ART

Recent models of mobile telephones typically incorporate a camera module. Manually focusing a camera module is difficult; automatic focusing is an essential function. To automatically focusing a camera module, a lens driving device is used. Meanwhile, with reduction in the thickness and size of a mobile telephone achieved, decreasing a space for incorporating a lens driving device is increasingly demanded. To satisfy this demand, many lens driving devices employ a structure with such as moving-magnet type linear driving method for driving a lens unit. This structure typically simplifies the configuration as compared to a structure using a stepping motor, and thus it is known that downsizing a lens driving device can be achieved. FIGS. 9 through 11 show an example of a lens driving device with a structure employing the moving-magnet type linear driving method.

Lens driving device 101 shown in FIGS. 9 and 10 has magnet 120 attached to holder 110 holding lens unit 113 including optical lens 111 and lens barrel 112. Meanwhile, coil 160 is attached to column 132 extended in the direction of the optical axis from base 130 fixed to the camera module body. Further, magnetic body 170 is provided radially outward of coil 160. Base 130 further includes Hall effect sensor 104 for measuring the position of holder 110. Position information measured by Hall effect sensor 104 is sent to CPU (central processing unit) 105. CPU 105 moves holder 110 through driver 106.

Concretely, driver 106 applies coil 160 with a current to generate an electromagnetic driving force, which causes magnet 120 attached to holder 110 to receive a force in the direction of the optical axis. As a result, holder 110 moves in the direction of the optical axis of lens unit 113. When the current is stopped, the electromagnetic driving force stops, and thus movement of holder 110 stops as well. Further, magnet 120 attached to holder 110 is attracted to magnetic body 170, which retains holder 110 at the position where it has stopped. In other words, magnet 120, coil 160, magnetic body 170, Hall effect sensor 104, CPU 105, and driver 106 form a holder move-and-stop mechanism for moving and stopping holder 110 in the direction of the optical axis.

In the meantime, as shown in FIGS. 11A through 11C, holder 110 is provided with guide units 115 and 116. When holder 110 described above moves, guide units 115 and 116 slidingly contact the sides of shafts 151 and 152, which then guides the moving direction of holder 110 in the direction of the optical axis of lens unit 113. However, if guide unit 115 is a through hole with its cross section similar to that of shaft 151 for example, contact section 115a where guide unit 115 contacts the side of shaft 151 is a single point, the position of which can change according to movement of holder 110. In other words, holder 110 moves in the direction of the optical axis while repeating contact and separation between contact section 115a of guide unit 115 and the side of shaft 151. Movement of holder 110 accompanied by such contact and separation may be a cause of looseness in movement.

As a result, some techniques are presented for preventing looseness of a lens carrier (holder) (refer to patent literatures 1 and 2 for example). Patent literature 1 and its improved invention, namely patent literature 2, describe as follows. “Since a lens carrier has been moved to one side by urging the lens carrier in the direction orthogonal to the optical axis by means of an urging force from both ends of the torsion spring, a through hole provided in the lens carrier is always in contact with the guide shaft . . . . Further, when changing the imaging magnification, the lens carrier moves while slidingly contacting the inner circumferential surface of the through hole and the guide shaft. This prevents looseness while the lens carrier is moving to enable adjusting the imaging magnification accurately.” (patent literatures 1 and 2)

### CITATION LIST

### Patent Literature

PTL 1: Japanese Patent Unexamined Publication No. 2006-91408

PTL 2: Japanese Patent Unexamined Publication No. 2006-178269

### SUMMARY OF THE INVENTION

To achieve such advantages, the following conditions need to be satisfied (PTL 1, PTL 2). That is, a notch is formed for containing a torsion spring supported by a guide shaft between the through holes. A lens carrier is moved to one side with respect to the circumferential surface of the guide shaft by urging the lens carrier in the direction orthogonal to the optical axis by means of an urging force from both ends of the torsion spring contained in the notch. In summary, a notch needs to be formed in the guide unit to contain a torsion spring, requiring minute processing as well as a special, additional torsion spring, which increases the number of components. Further, since the lens carrier is moved to one side with respect to the circumferential surface of the guide shaft by urging the lens carrier in the direction orthogonal to the optical axis by means of an urging force from both ends of the torsion spring, adjusting the level of urging is difficult. Especially, to apply the invention to a small lens unit used for a mobile telephone, a too strong urging by the torsion spring may interfere with movement itself of the holder.

The present invention has been accomplished in view of the above circumstances. An object of the invention is to provide a lens driving device that prevents looseness during movement of the holder that is caused by repeated contact and separation between the sliding contact sections and the shaft, with a simple configuration. Another object of the invention is to provide a camera module incorporating the lens driving device, and a mobile telephone incorporating the camera module.

A lens driving device according to the present invention includes a holder that holds a lens unit and is movable in the direction of the optical axis of the lens unit; and a columnar shaft extended in the direction of the optical axis of the lens unit. The lens driving device further includes a guide unit disposed on the holder that slidingly contacts the side of the shaft and guides the moving direction of the holder in the direction of the optical axis of the lens unit when the holder moves. The guide unit includes a plurality of sliding contact sections which keep slidingly contacting the side of the shaft while the holder is moving.

According to the above-described configuration, the guide unit includes multiple sliding contact sections that always continue to slidingly contact the same part of the side of the shaft while the holder is moving, which prevents repeated contact and separation between the sliding contact section and the shaft. Accordingly, this prevents looseness during movement of the holder caused by the repeated contact and separation.

In a lens driving device of the present invention, preferably the multiple contacting sections keep slidingly contacting the side of the shaft at the same position while the holder is moving by receiving a force in the direction vertical to the optical axis.

According to the above-described configuration, the multiple contacting sections always continue to slidingly contact the side of the shaft at the same part while the holder is moving by receiving a force in the direction vertical to the optical axis, which prevents repeated contact and separation between the sliding contact sections and the shaft. Accordingly, this prevents looseness during movement of the holder caused by the repeated contact and separation. Here, a force in the direction vertical to the optical axis is not particularly limited; however, it may be a physical force caused by a material formed on the holder and the guide unit or a force based on an electromagnetic force or attractive force.

The lens driving device according to the present invention further includes a magnet attached to the holder; and a magnetic body disposed at a position where the magnet receives an attractive force in the direction vertical to the optical axis. A force that the sliding contact sections receive in the direction vertical to the optical axis is preferably generated by receiving the attractive force through the holder.

According to the above-described configuration, a force that the sliding contact sections receive in the direction vertical to the optical axis is generated by receiving the attractive force through the holder, which dispenses with providing a special material at the space-limited guide unit or its proximity and with forming a special structure. The attractive force is generated by a magnetic force, which facilitates adjusting the attractive force by adjusting the magnetic force of the magnet, the type and size of the magnetic body, and the distance between the magnet and the magnetic body.

With a lens driving device of moving-magnet type linear driving method for example, the holder includes a magnet, and the magnetic body is typically disposed radially outward of the holder, thereby generating the above-described attractive force without using a special magnet and a magnetic body.

With a lens driving device of the present invention, the cross-section shape of the surface vertical to the optical axis, of the guide unit includes a V shape having a vertex projecting in the direction opposite to the direction vertical to the optical axis, where each side of the vertex has the sliding contact sections disposed thereon.

According to the above-described configuration, the cross-section shape of the surface vertical to the optical axis, of the guide unit includes a V shape having a vertex projecting in the direction opposite to the direction vertical to the optical axis, where each side of the vertex has sliding contact sections disposed thereon. Accordingly, sliding contact sections can be easily formed that always continue to slidingly contact the side of the shaft at the same part while the holder is moving. Further, the V shape has a vertex projecting in the direction opposite to the direction vertical to the optical axis. Accordingly, the sliding contact sections are pressed against the shaft by a force in the direction vertical to the optical axis, which allows the sections to always continue to slidingly contact the side of the shaft at the same part while the holder is moving.

In the lens driving device of the present invention, the guide unit is preferably provided at the side in the radial direction, of the holder, and is a groove extended in the direction of the optical axis.

According to the above-described configuration, the guide unit is provided at the side in the radial direction, of the holder and is a groove extended in the direction of the optical axis, which can be easily formed. Further, the shaft can be easily detached as compared to a case where the guide unit is a through hole formed in the direction of the optical axis, for example.

A camera module according to the present invention features incorporating the above-described lens driving device. The lens driving device suppresses looseness during movement of the holder, thereby achieving high driving accuracy. Accordingly, a camera module incorporating the lens driving device can achieve high accuracy.

A mobile telephone according to the present invention features incorporating the above-described camera module. The camera module can be compact and at the same time highly accurate, and thus is favorable as a camera module incorporated in a mobile telephone.

The present invention provides a lens driving device that prevents looseness during movement of the holder caused by repeated contact and separation between the sliding contact sections and the shaft, with a simple configuration. The invention provides a camera module incorporating the lens driving device and a mobile telephone incorporating the camera module.

### BRIEF DESCRIPTION OF DRAWINGS

FIG. 1 illustrates an embodiment of a mobile telephone according to the present invention, a schematic diagram showing a state where the mobile telephone is folded.

FIG. 2 illustrates an embodiment of a mobile telephone according to the present invention, a schematic diagram showing a state where the mobile telephone is unfolded, where FIG. 2A is a perspective view showing the inner surface; FIG. 2B, a perspective view showing the back surface.

FIG. 3 illustrates an embodiment of a mobile telephone according to the present invention, a schematic diagram showing a configuration of the camera module.

FIG. 4 illustrates an embodiment of a mobile telephone according to the present invention, an exploded perspective view of a camera module incorporated in the mobile telephone.

FIG. 5 illustrates an embodiment of a mobile telephone according to the present invention, a perspective view of the lens driving device.

FIG. 6 illustrates an embodiment of a mobile telephone according to the present invention, where FIG. 6A is a perspective view of the holder of the lens driving device; FIG. 6B, a plan view of the lens driving device; FIG. 6C, an enlarged view of the substantial part of FIG. 6B.

FIG. 7 illustrates the second embodiment of a mobile telephone according to the present invention, an enlarged view of the substantial part of the holder.

FIG. 8 illustrates the third embodiment of a mobile telephone according to the present invention, an enlarged view of the substantial part of the holder.

FIG. 9 illustrates a conventional lens driving device, a perspective view of the lens driving device.

FIG. 10 illustrates a conventional lens driving device, a schematic diagram of a configuration of a camera module.

FIG. 11 illustrates a conventional lens driving device, where FIG. 11A is a perspective view of the holder of the lens driving device; FIG. 11B, a plan view of the lens driving device; FIG. 11C, an enlarged view of the substantial part of FIG. 11B.

FIG. 12 illustrates an embodiment of a mobile telephone according to the present invention, where FIG. 12A is a plan view of the holder of the lens driving device; FIG. 12B, an enlarged view of the substantial part of FIG. 12A; FIG. 12C, another enlarged view of the substantial part of FIG. 12A.

### DESCRIPTION OF EMBODIMENTS

### First Exemplary Embodiment

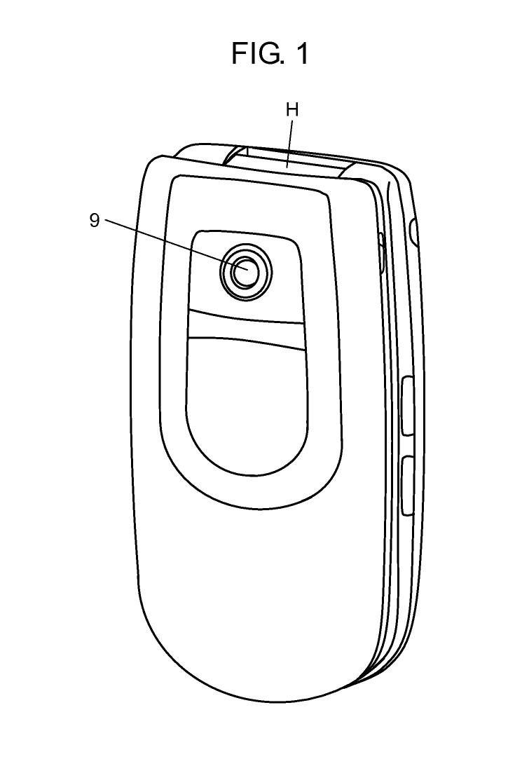

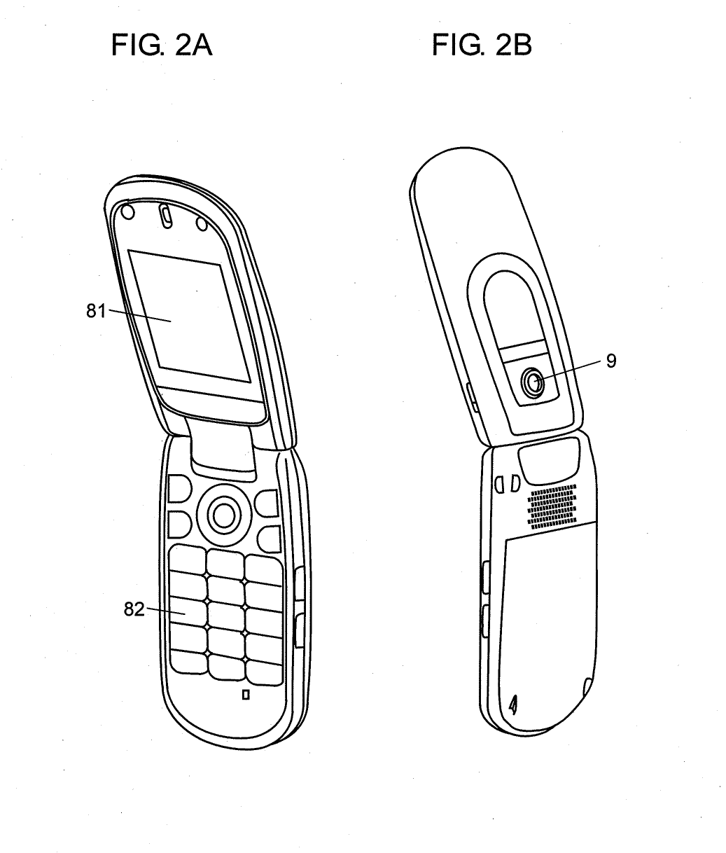

Hereinafter, a description is made of an embodiment of a mobile telephone of the present invention using the related drawings. As shown in FIG. 1, the mobile telephone is foldable centering on hinge H. FIG. 1 shows a folded state, where cover glass 9, a part of the camera module, is exposed on the front. FIG. 2A shows a state where the mobile telephone is unfolded with display unit 81 and operation unit 82 on the front. FIG. 2B shows the mobile telephone unfolded viewed from the back. The user points cover glass 9 at an object with the telephone unfolded, and while viewing the image on display unit 81, the user operates operation unit 82 to release the shutter for photographing the object.

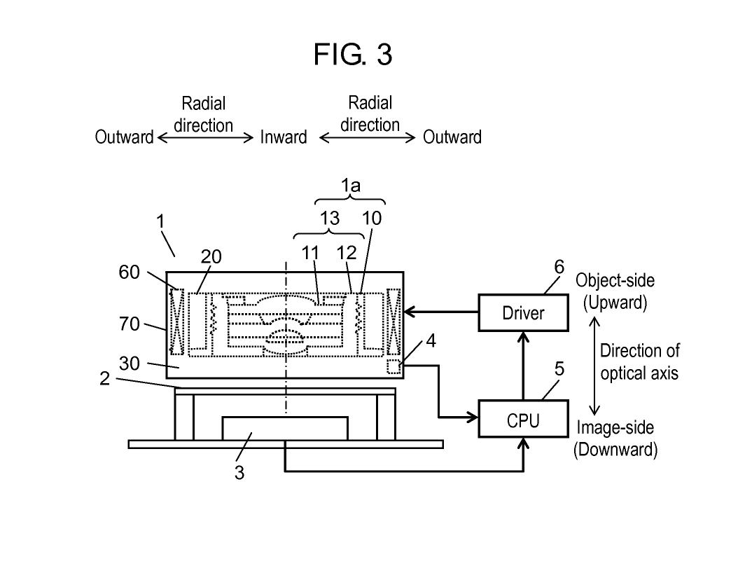

Next, a description is made of a configuration of the camera module in a case where lens driving device 1 of the embodiment is incorporated into a camera, in reference to FIG. 3.

As shown in FIG. 3, lens driving device 1 has filter 2 and image sensor 3 disposed at the side of base 30. Base 30 has Hall effect sensor 4 disposed thereon as a position sensing element. The position of lens module 1a is determined according to a signal from Hall effect sensor 4.

When focusing, CPU (central processing unit) 5 controls driver 6 to move lens module 1a from the home position to a predetermined position toward the object in the direction of the optical axis. At this moment, a position detection signal from Hall effect sensor 4 is input into CPU 5. Simultaneously, CPU 5 processes a signal input from image sensor 3 to acquire a contrast value of a photographing image. CPU 5 repeats the action to acquire the position of lens module 1a with the best contrast value as a focusing position.

After that, CPU 5 drives lens module 1a to the focusing position. Concretely, CPU 5 monitors a signal from Hall effect sensor 4 to drive lens module 1a until the signal becomes a state corresponding to the focusing position. This action moves lens module 1a to the focusing position.

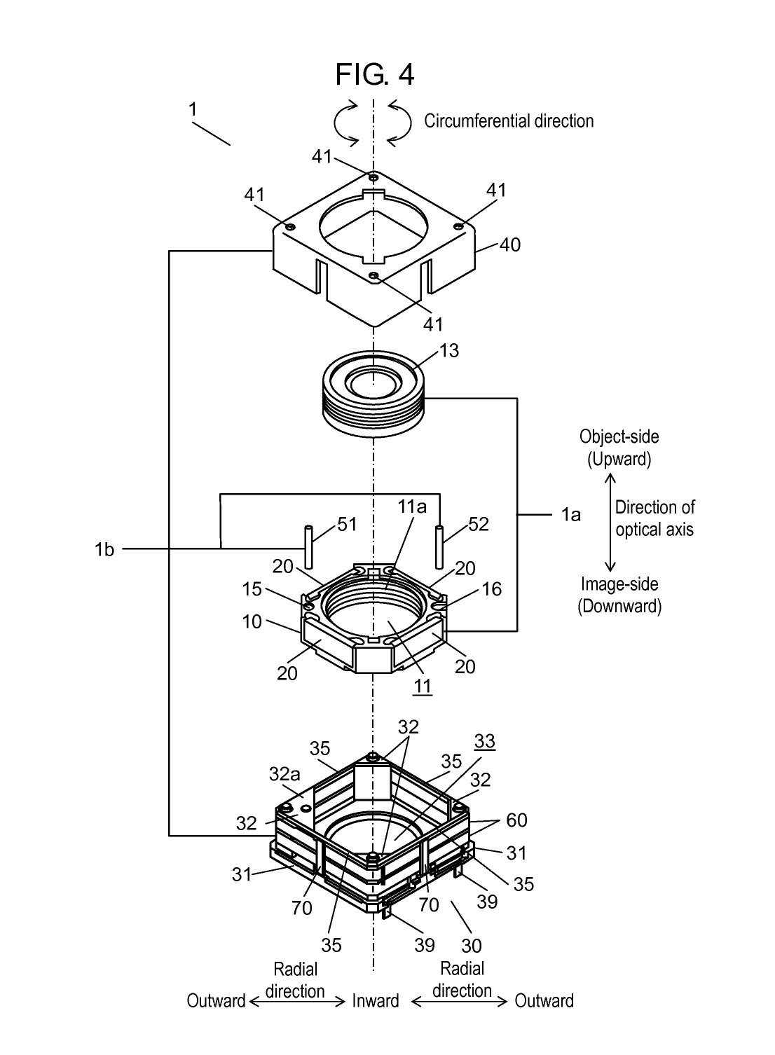

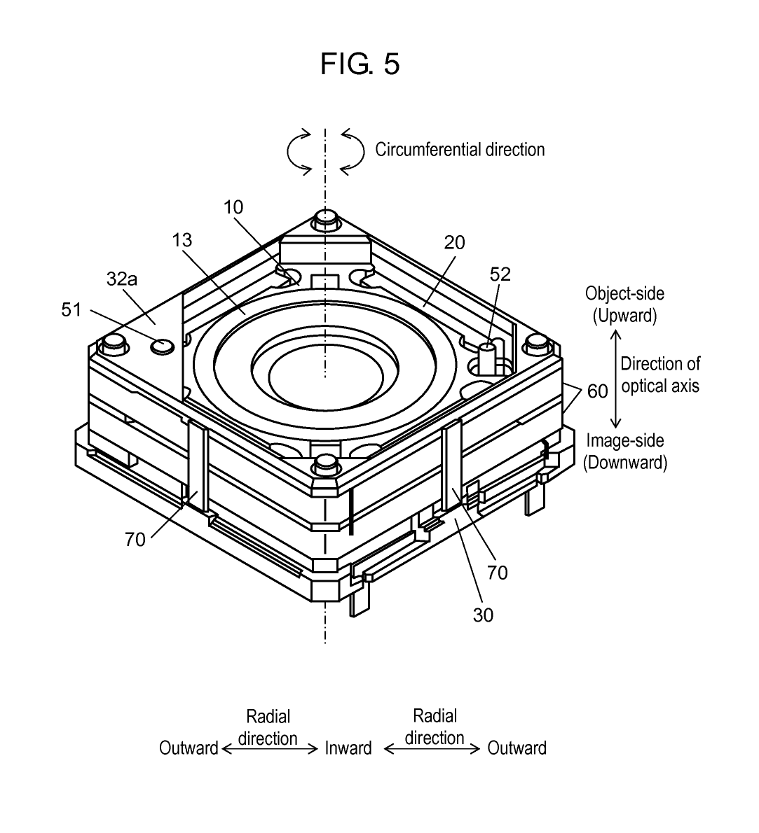

Next, a concrete description is made of the general configuration of lens driving device 1 for driving lens module 1a in reference to FIGS. 4 and 5. Lens driving device 1 is composed of lens module 1a movable in the direction of the optical axis; and stationary body 1b that provides lens module 1a with a driving force and is fixed to a device incorporating this lens driving device 1. Lens driving device 1 moves lens module 1a in the direction of the optical axis to achieve automatic focusing. Lens driving device 1 of the embodiment is formed in a square of approximately 8.5 mm in a planar view through the optical axis and is formed approximately 3 mm in the height along the direction of the optical axis.

As shown in FIG. 3, lens module 1a is composed of lens unit 13 including multiple optical lenses 11 and lens barrel 12 holding lenses 11; holder 10 formed of a resin holding lens unit 13; and multiple magnets 20 fixed to holder 10. Here, four magnets 20 of the embodiment are fixed to holder 10 so as to surround lens unit 13 from radially outward of lens unit 13 circumferentially at regular intervals. Holder 10 is formed by injection-molding resin material. On this occasion, magnets 20 can be preliminarily attached to a mold for forming holder 10 to integrally mold holder 10 and magnets 20 simultaneously with the injection molding. This process increases the bonding strength between magnets 20 and holder 10 as compared to a case where they are joined together with an adhesive. Further, this process dispenses with a process for attaching magnets 20, which as well reduces the cost.

Stationary body 1b includes base 30 and cover 40 both composing the outer frame of lens driving device 1; the above-described shafts (i.e. main shaft 51 and auxiliary shaft 52) fixed to base 30, for guiding movement of holder 10 in the direction of the optical axis; and coil 60 for forming a magnetic field by a current applied. Radially outside of coil 60, magnetic body 70, which is a rectangle, plate-like magnetic material formed of a magnetic steel plate, is fixed to base 30.

Base 30 is provided thereon with base unit 31 forming the bottom surface of the outer frame of lens driving device 1; and columns 32 extended from base unit 31 along the direction of the optical axis. Base unit 31 is formed in a square in a planar view through the optical axis. Columns 32 are respectively placed at the four corners of base unit 31. The central position of base unit 31 has opening 33 (a round through hole) formed therein.

Of columns 32, the side facing an object, close to main shaft 51 is extended radially inward to form object-side stopper 32a to limit object-side movement with contact of the object side of lens module 1a. Meanwhile, to limit image-side movement with contact of the image side of lens module 1a, base unit 31 (i.e. the image side of base 30) works.

Object-side stopper 32a is provided with a top-end support hole, which is a through hole for supporting the upper end (referred to as simply “top end” hereinafter) of main shaft 51 in the direction of the optical axis. Meanwhile, base 30 is further provided with a shaft bottom-end supporting part (unillustrated), which is a recess for supporting the lower end (referred to as simply “bottom end” hereinafter) in the direction of the optical axis, of main shaft 51 with its central axis pointing in the direction of the optical axis of lens unit 13. Accordingly, the top end of main shaft 51 is supported by the top-end support hole, and the bottom end is supported by the shaft bottom-end supporting part. Base 30 is further provided with a shaft bottom-end supporting part (unillustrated), which is a recess for supporting the bottom end of auxiliary shaft 52, and only the bottom end of auxiliary shaft 52 is supported by the shaft bottom-end supporting part. As a result that holder 10 is inserted in a manner such that holder 10 can slide on main shaft 51 and auxiliary shaft 52, lens module 1a that has received a force to move lens module 1a in the above-described direction of the optical axis becomes movable in the direction of the optical axis guided by main shaft 51 and auxiliary shaft 52.

Further, cover 40 forming the outer side and the top surface of lens driving device 1 is attached to base 30 so as to surround the radially outer side of coil 60. The top surface of cover 40 has multiple through holes 41 therein for inserting the upper end in the direction of the optical axis, of multiple columns 32, and the bottom of cover 40 is fixed to base unit 31 with the respective corresponding ends inserted.

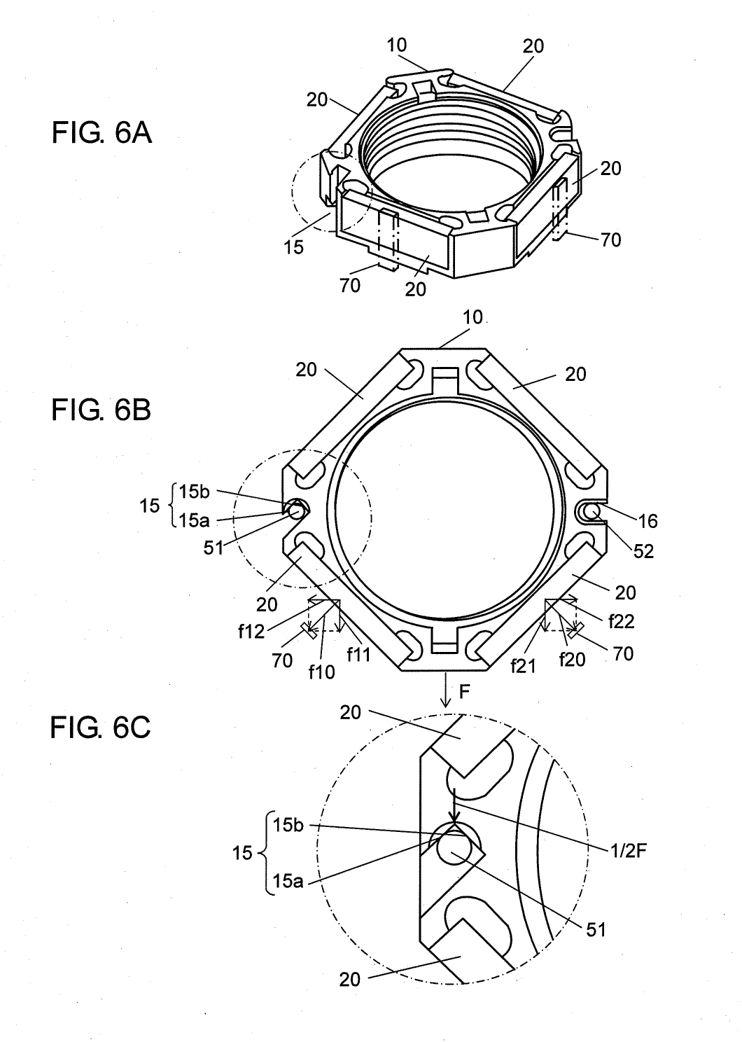

As shown in FIGS. 6A and 6B, this holder 10 is provided with main shaft guide unit 15, which is a groove provided in a radial side of holder 10 and extended in the direction of the optical axis. Main shaft guide unit 15 slidingly contacts main shaft 51 of the two columnar shafts and guides movement of holder 10. Similarly, holder 10 is provided with auxiliary shaft guide unit 16, which is a groove provided in a radial side of holder 10 and extended in the direction of the optical axis. Auxiliary shaft guide unit 16 slidingly contacts auxiliary shaft 52 and guides movement of holder 10. Concretely, main shaft 51 and auxiliary shaft 52 are disposed in the direction of the optical axis of lens unit 13. Accordingly, as a result that holder 10 is moved in a state where the inner circumferential surface of main shaft guide 15 slidingly contacts the outer circumferential surface of main shaft 51 and the inner circumferential surface of auxiliary shaft guide unit 16 slidingly contacts the outer circumferential surface of auxiliary shaft 52, lens module 1a can be moved in the direction of the optical axis.

The cross-section shape of the surface vertical to the optical axis, of main shaft guide unit 15, which is a groove extended in the direction of the optical axis, of holder 10 includes a V shape. Here as shown in FIG. 6B, two magnets 20 fixed to holder 10 respectively receive attractive forces f10 and f20 in the direction vertical to the optical axis from two magnetic bodies 70 fixed to base 30. When magnetic bodies 70 are formed of the same material and so are magnets 20, attractive forces f10 and f20 have the same strength. Accordingly, vector synthesis of f10 and f20 produces component forces f12 and f22 of f10 and f20, respectively. Since f12 and f22 are in the directions opposite to each other, f12 and f22 cancel each other, which causes holder 10 to receive f11 plus f21 in the direction vertical to the optical axis. The two guide units (i.e. main shaft guide unit 15 and auxiliary shaft guide unit 16) receive attractive force F through holder 10, where F is f11 plus f21.

Main shaft guide unit 15 and auxiliary shaft guide unit 16 are assumed to evenly receive a component of attractive force F. FIG. 6C, an enlarged view, illustrates an example where main shaft guide unit 15 receives ½ F (a half of attractive force F) as a force in the direction vertical to the optical axis. The vertex of the V shape projects in the direction opposite to that of ½ F (in the direction vertical to the optical axis) on the above-described cross-section shape of main shaft guide unit 15. Accordingly, main shaft guide unit 15 is pressed against main shaft 51 in a manner such that the vertex approaches. Consequently, each of the two sides forming the V shape is provided with two sliding contact sections 15a and 15b both slidingly contacting main shaft 51.

The positional relationship between magnetic body 70 and magnet 20 does not particularly change, causing ½ F (vertical to the optical axis) to always continue to be exerted while holder 10 is moving. Accordingly, main shaft guide unit 15 is pressed against main shaft 51 with a force of the same direction and strength while holder 10 is moving. Consequently, sliding contact sections 15a and 15b continue to slidingly contact main shaft 51 without changing the position (i.e. at the same position) while holder 10 is moving, which prevents repeated contact and separation between the sliding contact sections and main shaft 51. Accordingly, this prevents looseness during movement of holder 10 caused by the repeated contact and separation.

Lens driving device 1 according to the embodiment provides the following advantages.

(1) In the embodiment, main shaft guide unit 15 is provided with multiple sliding contact sections 15a and 15b that always continue to slidingly contact the side of main shaft 51 at the same position while holder 10 is moving, which prevents repeated contact and separation between the sliding contact sections and main shaft 51. Accordingly, this prevents looseness during movement of holder 10 caused by the repeated contact and separation.

(2) Multiple sliding contact sections 15a and 15b receive force ½ F in the direction vertical to the optical axis, and thus always continue to slidingly contact the side of main shaft 51 at the same position while holder 10 is moving, which prevents repeated contact and separation between the sliding contact sections and main shaft 51. Accordingly, this prevents looseness during movement of holder 10 caused by the repeated contact and separation. Here, a force in the direction vertical to the optical axis is not particularly limited; however, it may be a physical force caused by a material formed on the holder and the guide unit or a force based on an electromagnetic force or attractive force.

(3) In the embodiment, force ½ F that sliding contact sections 15a and 15b receive in the direction vertical to the optical axis is generated as a result that sections 15a and 15b receive attractive force F through holder 10, which dispenses with providing a special material at space-limited main shaft guide unit 15 or its proximity and with forming a special structure. Attractive force F is generated by a magnetic force, which facilitates adjusting the attractive force by adjusting the magnetic force of magnet 20, the type and size of magnetic body 70, and the distance between magnet 20 and magnetic body 70.

(4) In the embodiment, the lens driving device has a structure using moving-magnet type linear driving method, and thus normally includes magnet 20 to move holder 10. Further, the lens driving device normally includes magnetic body 70 radially outward of holder 10 to retain holder 10 that has stopped. Accordingly, the above-described attractive force F can be generated without using a special magnet and magnetic body, which means that no additional components are required.

(5) In the embodiment, the cross-section shape of the surface vertical to the optical axis, of main shaft guide unit 15 includes a V shape having a vertex projecting in the direction opposite to the direction of force ½ F in the direction vertical to the optical axis, where each side of the vertex has sliding contact sections 15a and 15b disposed thereon. Thus, these sections can be easily formed.

(6) In the embodiment, main shaft guide unit 15 is provided on the radial side of holder 10 and is a groove extended in the direction of the optical axis. Accordingly, main shaft guide unit 15 is formed by resin molding more easily than formed as a through hole. Further, main shaft 51 is detached more easily than a case where main shaft guide unit 15 is formed as a through hole in the direction of the optical axis.

(7) A lens driving device according to the embodiment suppresses looseness during movement of the holder, and thus can be a device with high driving accuracy. Accordingly, a camera module incorporating the lens driving device can be highly accurate.

(8) A mobile telephone according to the embodiment incorporates the above-described camera module compact and highly accurate, and thus can be a compact mobile telephone with a highly accurate photograph function. Accordingly, the invention is suitably used for a mobile telephone especially requiring compactness.

### Second Exemplary Embodiment

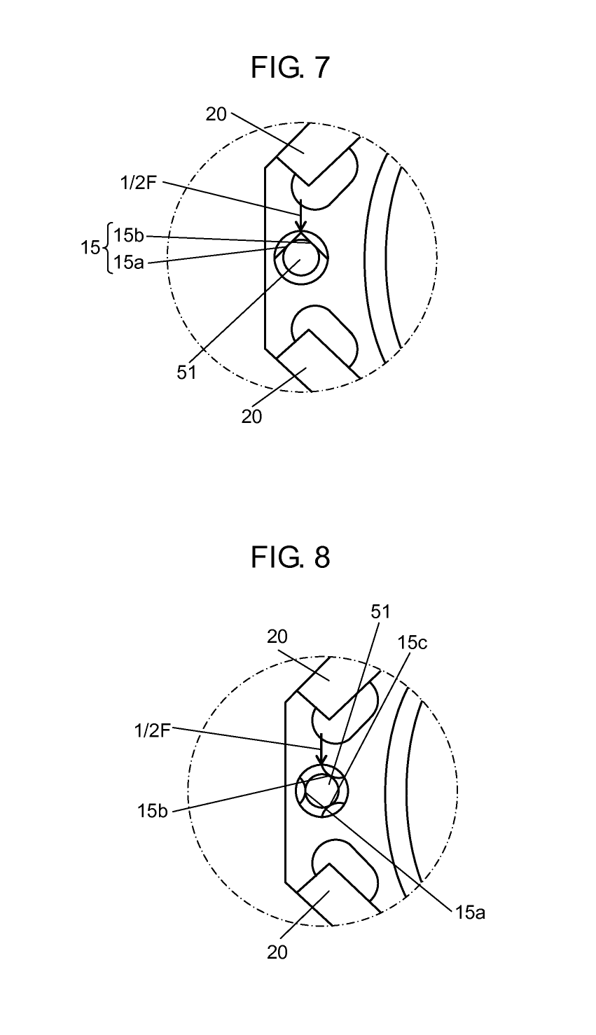

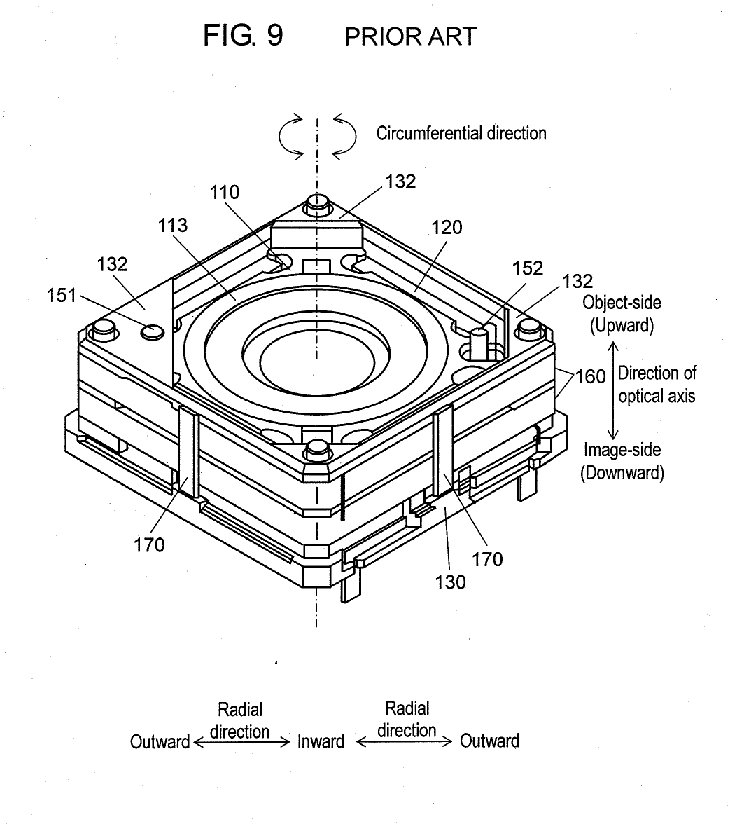

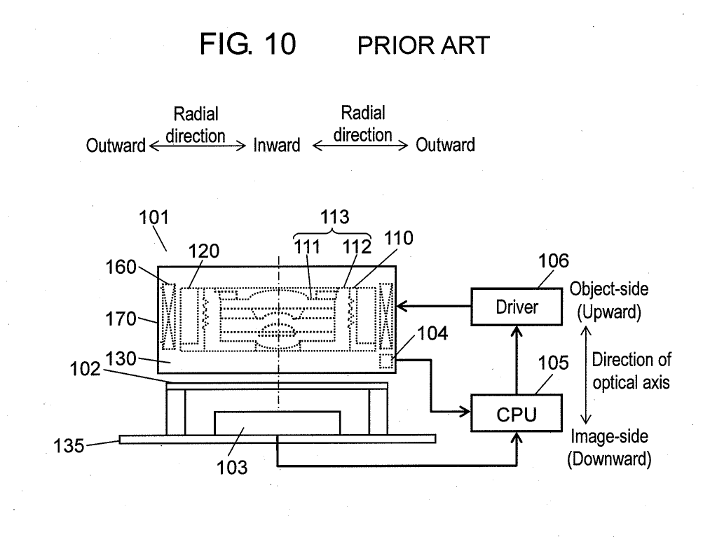

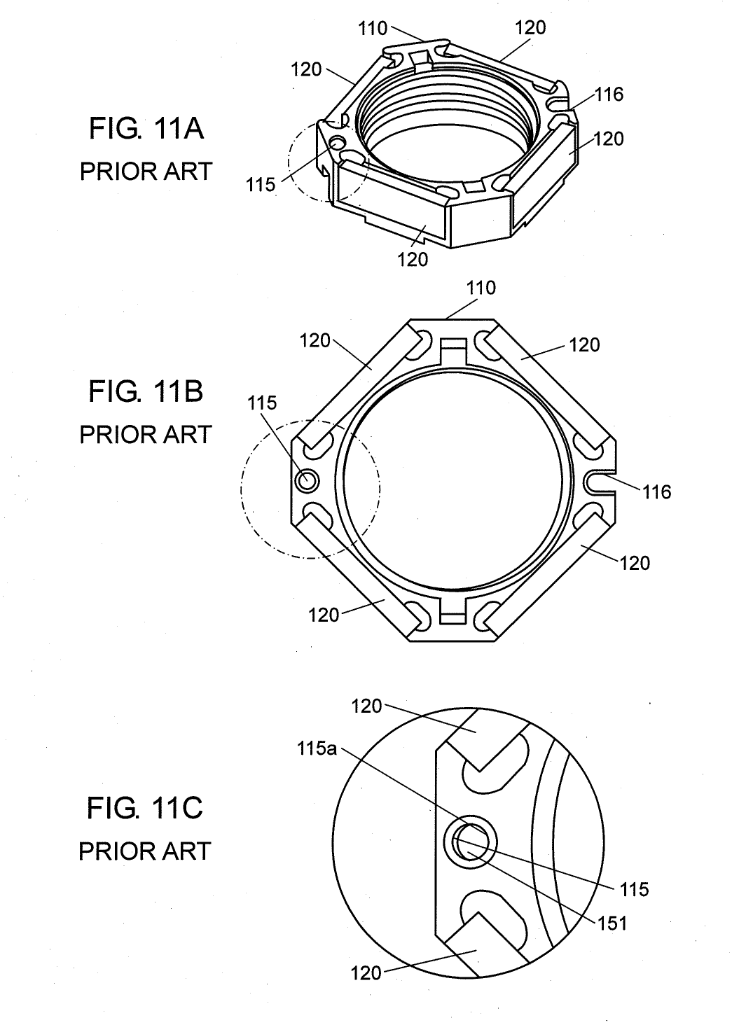

Next, a description is made of a mobile telephone according to the second embodiment of the present invention referring to FIG. 7. The second embodiment is structured so that only the structure of holder 10, especially main shaft guide unit 15, of the first embodiment is changed, and thus detailed description is omitted for the same part.

In the second embodiment, as shown in FIG. 7, main shaft guide unit 15 is formed as a through hole extended in the direction of the optical axis, of holder 10 instead of a groove extended in the direction of the optical axis, of holder 10. Even in this case, the cross-section shape of the surface vertical to the optical axis, of main shaft guide unit 15 includes a V shape, and the vertex of the V shape projects in the direction opposite to that of force ½ F in the direction vertical to the optical axis. Accordingly, similarly to the first embodiment, main shaft guide unit 15 is pressed against main shaft 51 with a force of the same direction and strength while holder 10 is moving, and thus sliding contact sections 15a and 15b resultingly continue to slidingly contact main shaft 51 without changing the position while holder 10 is moving. The result prevents repeated contact and separation between the sliding contact sections and main shaft 51, which prevents looseness during movement of holder 10 caused by the repeated contact and separation.

Accordingly, a lens driving device of the second embodiment provides the same advantages described in the first embodiment, except for (6).

### Third Exemplary Embodiment

Next, a description is made of a mobile telephone according to the third embodiment of the present invention referring to FIG. 8. The third embodiment is structured so that only the structure of holder 10, especially main shaft guide unit 15, of the first and second embodiments has been changed, and thus detailed description is omitted for the same part.

In the third embodiment as well, as shown in FIG. 8, main shaft guide unit 15 is formed as a through hole extended in the direction of the optical axis, of holder 10. The cross section of the surface vertical to the optical axis, of main shaft guide unit 15 has three sliding contact sections 15a, 15b, and 15c formed as a result that the inner circumferential surface of the through hole projects toward the central axial direction of the through hole. Resultingly, even if force ½ F (shown in the figure) in the direction vertical to the optical axis is not present, sliding contact sections 15a, 15b, and 15c continue to slidingly contact main shaft 51 without changing the position while holder 10 is moving. The result prevents repeated contact and separation between the sliding contact sections and main shaft 51, which prevents looseness during movement of holder 10 caused by the repeated contact and separation.

Accordingly, lens driving device 1 of the third embodiment as well provides the advantage same as those of the second one, with the following additional advantages.

(9) In the third embodiment, three sliding contact sections 15a, 15b, and 15c are formed. Consequently, these sections slidingly contact main shaft 51 at the three points, and resultingly continue to slidingly contact main shaft 51 at the same position while holder 10 is moving even if force ½ F in the direction vertical to the optical axis is not present. Accordingly, the invention is applicable to a lens driving device without requiring magnetic body 70 as well, and thus can be used further widely.

### Fourth Exemplary Embodiment

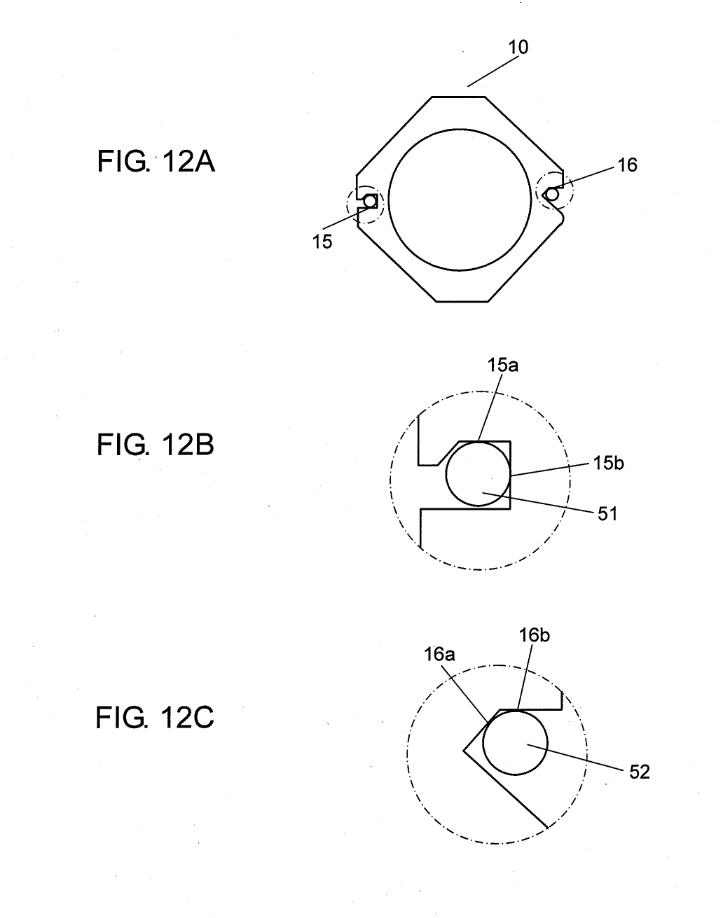

Next, a description is made of a mobile telephone according to the fourth embodiment of the present invention referring to FIG. 12. The fourth embodiment is structured so that only the structure of holder 10, especially main shaft guide units 15 and 16, of the first, second, and third embodiments is changed, and thus detailed description is omitted for the same part.

In the forth embodiment as well, as shown in FIG. 12, main shaft guide unit 15 and auxiliary shaft guide unit 16 are formed as through holes extended in the direction of the optical axis, of holder 10 (same as the FIG. 6 except for the guide units, and thus detailed description is omitted). The cross section of the surface vertical to the optical axis, of main shaft guide unit 15 has two sliding contact sections 15a and 15b formed as a result that the V shape is formed of a polygon. Similarly, auxiliary shaft guide unit 16 has two contact sections 16a and 16b formed. The result prevents repeated contact and separation between the sliding contact sections, and main shaft 51 and auxiliary shaft 52, which prevents looseness during movement of holder 10 caused by the repeated contact and separation.

Accordingly, lens driving device 1 of the fourth embodiment as well provides the advantages same as those of the first one. Further, auxiliary shaft guide unit 16 as well is provided with multiple sliding contact sections, which prevents looseness during movement of holder 10 caused by repeated contact and separation between the sliding contact sections and auxiliary shaft 52, providing more advantages.

The embodiment provides the advantages same as those of the first one even if only main shaft guide unit 15 is changed as shown in FIG. 12B and auxiliary shaft guide unit 16 remains the same as shown in FIG. 6B.

The embodiment may be changed as follows.

In the third embodiment, there are three sliding contact sections 15a, 15b, and 15c, but another configuration may be used. The point is, three or more sliding contact sections resultingly continue to slidingly contact main shaft 51 at the same position while holder 10 is moving even if force ½ F in the direction vertical to the optical axis is not present, and thus there may be four or more sliding contact sections. A favorable number of sliding contact sections can be selected in consideration of machinability and dynamic friction during movement.

In the third embodiment, the cross section of main shaft guide unit 15 has three sliding contact sections 15a, 15b, and 15c formed as a result that the inner circumferential surface of the through hole projects toward the center thereof, but another configuration may be used. Sliding contact sections may be formed with the cross section of the through hole being a polygon. A favorable shape of sliding contact sections can be selected in consideration of machinability and dynamic friction during movement.

In the cross-section shape of main shaft guide unit 15 in the second embodiment, the shape of the part facing the vertex of the V shape is not particularly limited. Since the part facing the vertex of the V shape does not slidingly contact main shaft 51, the shape may be determined in consideration of such as machinability.

In the above-described embodiment, force ½ F in the direction vertical to the optical axis is generated by receiving an attractive force between magnet 20 and magnetic body 70 through holder 10, but may be generated by another force. The point is, force ½ F may be caused by a physical force by a material of holder 10 and main shaft guide unit 15 or by a force based on an electromagnetic force or attractive force as long as the sliding contact sections receive a force in the direction vertical to the optical axis.

In the above-described embodiment, the invention is applied to the shape of main shaft guide unit 15 of the two guide units; however, it may be applied to auxiliary shaft guide unit 16 as well. In such a case, the shape of main shaft guide unit 15 may the same as or different from that of auxiliary shaft guide unit 16. The shape of main shaft guide unit 15 may be the same as a conventional one.

In the above-described embodiment, lens driving device 1 is incorporated into a camera module, but may be otherwise configured. When lens driving device 1 is incorporated into another optical device such as a telescope, microscope, and binoculars, automatic focusing function can be added to the optical device.

In the above-described embodiment, the camera module is incorporated into a mobile telephone, but may be otherwise configured. The camera module may be incorporated into a compact digital camera, digital single-lens reflex camera, film-based camera, and a digital or film-based video camera.

1. A lens driving device comprising:
a holder holding a lens unit and movable in a direction of an optical axis of the lens unit;
a columnar shaft extended in the direction of the optical axis of the lens unit; and
a guide unit disposed on the holder, the guide unit slidingly contacting a side of the shaft and guiding a moving direction of the holder in the direction of the optical axis of the lens unit when the holder moves,
wherein the guide unit includes a plurality of sliding contact sections which keep slidingly contacting the side of the shaft at a same position while the holder is moving.

2. The lens driving device of claim 1, wherein the plurality of sliding contact sections receive a force in a direction vertical to the optical axis and keep slidingly contacting the side of the shaft at the same position while the holder is moving.

3. The lens driving device of claim 2, further comprising:
a magnet attached to the holder; and
a magnetic body disposed at a position where the magnet receives an attractive force in the direction vertical to the optical axis,
wherein the force applied in the direction vertical to the optical axis received by the sliding contact sections is generated as a result that the sliding contact sections receive the attractive force through the holder.

4. The lens driving device of claim 2, wherein a cross-section shape of a surface vertical to the optical axis, of the guide unit, has an angle, and
wherein each side of the angle has the plurality of sliding contact sections disposed thereon.

5. The lens driving device of claim 2, wherein a cross-section shape of a surface vertical to the optical axis, of the guide unit, includes a V shape having a vertex projecting in a direction opposite to a direction of a force in the direction vertical to the optical axis, and
wherein each side of the vertex has the plurality of sliding contact sections disposed thereon.

6. The lens driving device of claim 2, wherein the guide unit is a groove provided at a radial side of the holder and extended in the direction of the optical axis.

7. A camera module including the lens driving device of claim 1.

8. A mobile telephone including the camera module of claim 7.
